(19) United States
(12) Patent Application Publication
(10) Pub. No.: US 2018/0273884 A1
(43) Pub. Date: Sep. 27, 2018

(54) Airag Vodka and Method of its Production

(71) Applicants: Nurbek Mukambetov, Bishkek (KG); Emilbek Khudoyarov, Bishkek (KG)

(72) Inventors: Nurbek Mukambetov, Bishkek (KG); Emilbek Khudoyarov, Bishkek (KG)

(21) Appl. No.: 15/995,157

(22) Filed: Jun. 1, 2018

Related U.S. Application Data
(60) Provisional application No. 62/532,404, filed on Jul. 14, 2017.

(30) Foreign Application Priority Data
Jun. 24, 2016 (KG) PCT/KG2016/00431

(51) Int. Cl. C12G 3/12; C12G 3/04; C12G 3/02

(52) U.S. Cl. CPC C12G 3/12; C12G 3/02; C12G 3/04

(57) ABSTRACT

Method of production of a new kind of alcoholic drink, named Airag Vodka. Airag Vodka is made purely from fermented horse milk called kurnis. The production process includes distillation and two-stage filtering. The production process entails no use of outside water to the raw material. Airag Vodka is original. It is uniquely distinct both from the traditional kumis moonshines and from traditional kinds of vodka made from vegetable material.

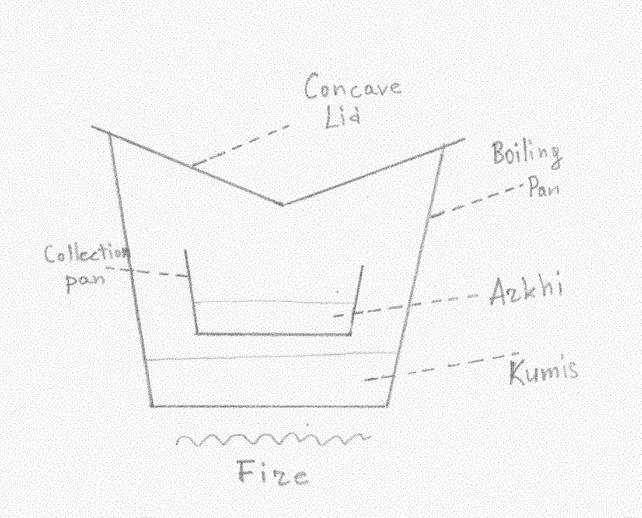

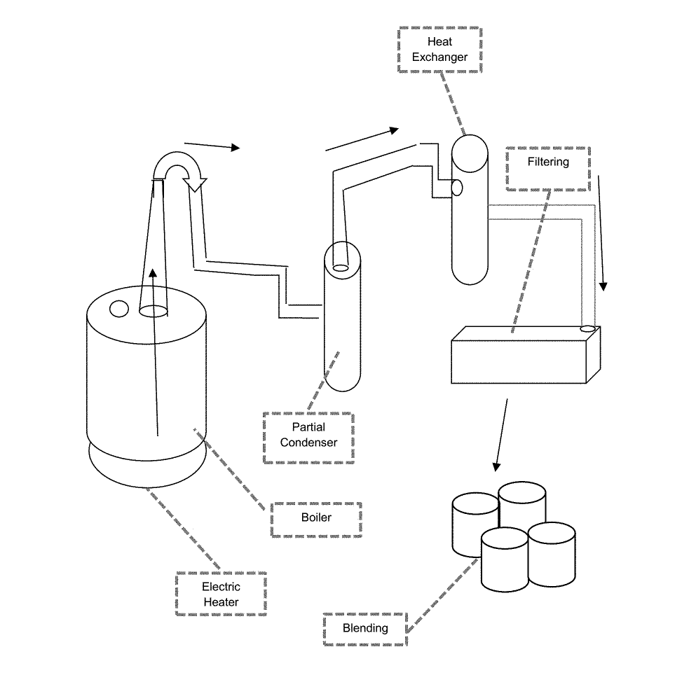

### BACKGROUND OF THE INVENTION

### Field of the Invention

The invention relates generally to a new kind of alcoholic drink, Airag Vodka, and the process of its production from kumis.

### Related Art

Vodka has for many centuries been one of popular strong alcoholic beverages. It is a distilled beverage composed primarily of water and ethanol, sometimes with traces of impurities and flavorings. Traditionally, vodka is made by distillation of cereal grains or potatoes that have been fermented, though some modern brands use other substances, such as fruits or sugar.

In a number of countries with pastoralist nomadic tradition an alcoholic beverage called kumis has been known for millennia. First written description of its production is believed to be from Herodotus in his 5^{th}-century BC Histories, Kurnis is made by fermentation of mare's milk. It is mild in terms of alcoholic content, generally below 3 percent.

On the basis of kumis a number of Mongolic and Turkic peoples, including Mongols and Altaians, have for centuries been making a stronger alcoholic beverage. It is called Arkhi in Mongolia and is widely produced in home conditions and consumed, especially in rural areas.

Arkhi is a product of a very basic distillation of kumis, using a stove and a simple collector of condensate. As such is has a low alcohol content comparable to that of strong wines rather than vodka, generally between 10 and 15 percent. Simple technology means that there is a notable residue of kurnis in Arkhi, resulting in a corresponding taste and smell.

### BRIEF SUMMARY OF THE INVENTION

The invention is an improvement in the traditional distillation process of production of Arkhi, addition thereto of two-staged filtration, and increasing alcohol content to 38-40 percent (depending on the desired taste nuances), resulting in a new type of alcoholic drink, which is named herein as Airag Vodka. Airag means kumis in Mongolian.

Airag Vodka is substantially different from both regular vodkas made from vegetable material and from Arkhi. Thus Airag Vodka is a distinctly new original drink.

### BRIEF DESCRIPTION OF THE DRAWINGS

The detailed description of the invention refers to the accompanying drawings, wherein:

Figure on the first sheet is a view of a technological line of production of the traditional Mongol Arkhi.

Figure on the second sheet is a view of the line of production Airag Vodka.

### DETAILED DESCRIPTION OF THE INVENTION

Production of Airag Vodka includes two main technological processes.

First is the production of kumis. It is a process that has been known to nomadic peoples for many centuries. Kumis is made by fermenting raw unpasteurized mare's milk with a liquid starter culture containing lactobacilli bacteria and yeasts. To induce better fermentation the raw material is physically agitated. Typically the process lasts a few days.

As a result of the first stage there is kumis, a carbonated and mildly alcoholic drink. To make a stronger alcoholic drink nomadic peoples such as Mongols and Siberian Turkic nations distillate Kumis (‘Airag’ in Mongolian) to produce a simple moonshine type of alcoholic drink.

In Mongolia it is called nowadays Arkhi. Production of Arkhi is also a traditional heritage of many nomadic cultures. It was probably an adaptation of the distillation process invented first, as is now believed by scholars, in medieval China. A typical Arkhi production process is shown graphically in the Drawings.

Arkhi contains generally between 10 and 15 percent alcohol. It has a strong odor of fermented milk and residues of proteins and fusel oils.

The present invention is a new kind of alcoholic drink from kumis and method of making the same.

As shown on the second sheet of the Drawings section, the method of production of Airag Vodka has two main stages, namely distillation and filtering.

Distillation is carried out in a standard still with a heat exchanger and partial distiller. Ready Kumis is heated and the evaporated part containing alcohol, essential and fusel oils, as well as some residual mixtures, is collected via a condensation process.

The partial condenser part functions to collect and remove unwanted fusel alcohols from the distillate.

Filtration process aims to remove all residues of milk, proteins and fusel alcohols, while preserving the natural flavoring from the grass, which is present in the raw material of kumis.

The filtration is carried out in two stages. In the first one, the distillate is put through a marble-sand filter. Solid matters remaining after the distillation are removed at this stage; and the liquor attains a clear bright optical quality.

The second stage of filtration uses a carbon-based filter. The filter removes unwanted organic substances, but keeps the essential oil with unique grass flavoring, giving Airag Vodka its unique taste and aroma.

The produced concentrate with varying alcohol content is blended at the final operation of production to make Airag Vodka contain from 38 to 40 percent of alcohol by volume.

Airag Vodka is a truly original and unique alcoholic beverage. There is no strong odor characteristic to vodkas made from vegetables, an inevitable result of the use of such raw material.

Traditional vodkas try to suppress the odor with various additives and recommendation to consume the product chilled. In the case of Airag Vodka there is no need for any artificial additives. The aroma is the same regardless of the temperature.

Airag Vodka is produced without addition of any foreign matters to the original horse milk, apart from the starter culture, most importantly without any outside water. It is generally known that quality of water affects the quality of produced vodka. In the case of Airag Vodka the only moisture used is that present in the horse milk, being a reason for its distinct quality.

The above production process aims to preserve a scent of grass present in kumis. That scent gives Airag Vodka a unique and immediately recognizable character.

What is claimed is:

1. A new alcoholic drink called Airag Vodka:
a) Based entirely on kumis made from horse milk
b) Filtered with carbon and marble-sand filters
c) Containing from 38 to 40 percent alcohol by volume

2. Method of production of claim 1, wherein said Airag Vodka is produced from pure kumis by distillation, filtering and blending to attain a 38 to 40 percent alcohol content.

3. Name of the claim 1 construed as general name of the said kind of alcoholic drink.
